(19) United States
(12) Patent Application Publication
(10) Pub. No.: US 2010/0030595 A1
(43) Pub. Date: Feb. 4, 2010

(54) Transactional Engine Linking Businesses to Multiple Recruitment Companies for Engagement & Management of Labour

(75) Inventor: Robert John Day, Sydney (AU)

Correspondence Address: MICHAEL MOLINS;MOLINS & CO., SUITE 5, LEVEL 6, 139 MACQUARIE ST, SYDNEY NSW, 2000, AU

(73) Assignee: EMPLOYMENT MANAGEMENT SYSTEMS PTY LIMITED, Sydney (AU)

(21) Appl. No.: 11/817,024

(22) PCT Filed: Feb. 27, 2006
(86) PCT No.: PCT/AU2006/000250

§ 371 Date: Jul. 17, 2009

(30) Foreign Application Priority Data
Feb. 25, 2005 (AU) 2005900863

(51) Int. Cl. G06Q 10/00; G06Q 30/00

(52) U.S. Cl. 705/7; 705/37

(57) ABSTRACT

The invention provides methods and business methods for processing and publishing business information, and for networked procurement and tracking of data such as cost, charge, and budget analysis, from a secure hub, based on the use of time sheets as the single source, for collection to a single location, for processing to produce reports which are then distributable to, buyers and suppliers of casual and permanent labour in a secure environment. The invention allows multiple buyers (e.g. companies), suppliers (e.g. agents) and workers to transact with multiple discrete levels or customised secure access levels, from only one database and requires no proprietary software at the user end apart from a web browser.

### FIELD OF THE INVENTION

The invention pertains to business methods and software relating to a networked solution for providing instant information and analysis of temporary and contract labour which has been supplied from a number of different suppliers. In preferred embodiments, the solution is supported by email and SMS notification.

### BACKGROUND OF THE INVENTION

Many businesses use multiple sources for casual or contractor (time sheet) labour. Management, compliance, visibility, budgets, control, costs, margins and cash flow analysis is therefore complicated because data must be collected from numerous sources and can take up to six weeks to complete and analyze in some industries. The problem of procuring and supplying casual labour is one of the prime areas that the invention seeks to address and examples in the specification are directed toward casual labour supply. However it will be understood that the methods disclosed below apply equally well to the procurement and supply of contract labour, temporary placements of a variety of types and permanent employment.

As an example, there are presently over 2.8 million casuals employed nationally in Australia. More than thirty percent of all new jobs created are in the casual labour market. It is clear that a demand currently exists for a single network solution in real time to manage the use of casual employees by business (buyer) and agencies (supplier).

Because of the complexity and cumbersome nature of prior art solutions, the need has existed for a centralised and networked procurement system that multiple businesses can use to contract with multiple recruitment agents for the supply of casual and contractors. A successful solution would have to avoid any change management on behalf of the labour buying companies yet allow a company to negotiate with multiple agents for supply and tracking of casuals and contractors.

Another challenge was to allow casual labourers to also have direct input into the same system for centralised work history, accepting jobs and filling in timesheets. This gives casual labourers the ability to select their preferred agents.

All current systems are a one agent to one business solution that requires a business to log in to each agent's system to use. Hence a buyer would have no centralized data regarding the use and welfare of casuals that worked for them.

A networked solution that is usable, securely, by companies (buyers of casual labour), agents (that supply labour) and the labourers or workers themselves is considered “three dimensional”. The challenge in building a system that is three dimensional is the security of the information entered. The system must manage quotes from different agents to avoid inadvertent publishing or viewing of other agent's quotes by unauthorized users. In preferred embodiments, the system manages the process of obtaining tenders and linking accepted contracts (agents and their prices) to job profiles. This information flows through the system and is visible at all times against the completed time sheets.

It is also a consideration that some legislation requires businesses to have auditable records available for their casual/contractor workforce as they do their permanent workforce. A practical solution would thus increase security compliance by having all casual employee data is stored in one secure location, i.e. a “one stop shop” for managing service compliance of casual staff, reducing costs to business through centralised control and compliance—enabling enforcement of corporate policies and contracts.

No existing solution offers labour buyers visibility, in a real time, to accurate, single views of accrued expenditure to all suppliers of casual staff, across the entire organisation.

### OBJECTS AND SUMMARY OF THE INVENTION

It is the object of this invention to provide methods of processing and publishing business information, business methods and software for networked procurement and tracking of data such as cost, charge, and budget analysis, from a secure hub, based on the use of time sheets as the single source, for collection to a single location, for processing to produce reports which are then distributable to, buyers and suppliers of casual and permanent labour in a secure environment. The invention optionally allows the selection and additional reporting functionality for expenses, safety issues and potential hazards.

The present invention seeks to manage, from a single web based location, orders from buyers and the filling of orders by multiple agents, tracking time against the quoted cost and cost centers. The system seeks to capture, on each job sheet, the details of the business person that placed the order, where the casuals had to report and the agent's consultant that filled the order even though the process may have passed through many different personnel at both the agent and business. Reports are produced for the agent to download into their payroll system along with reports showing their charges to the business supplied. These charge reports are automatically visible to the respective business showing how much they owe each agent. With current systems, businesses cannot raise an order until the work has been completed and the exact dollar amount to put on the order is known. Therefore, having real time and historical data is of significant value to the business, agent and casuals and is a real breakthrough.

The invention allows multiple buyers (e.g. companies), suppliers (e.g. agents) and workers to transact with multiple discrete levels or customised secure access levels, from only one database and requires no proprietary software at the user end apart from a web browser. Traditional software products such as SAP, Oracle etc require a proprietary software product at the user end and will only allow its own users to transact. The present invention allows users to view multiple suppliers or buyers. EMS provides exactly the same network security as provided by, say, Internet banking. The system may be built, using the Microsoft.Net platform.

In preferred embodiments, analysis may be done daily or at the time of the payroll run, with the ability to report by location, department, position, event, job (cost centre) overtime, time and a half, double time and allowances for paying, on-costs and charging.

Further, the system optionally allows searches to be done on a daily basis for any of the above information. Historical data on above information is also available.

### BRIEF DESCRIPTION OF THE DRAWINGS FIGURES

The following drawings have been referenced in the detailed description of the processes of the invention in order to aid in their explanation and understanding:

FIG. 1 is a diagram of current processes, showing how multiple businesses relate to multiple agencies to engage multiple workers.

FIG. 2 is a diagram showing how the application will sit as a transactional engine between business and suppliers of labour (agencies).

FIG. 3 illustrates a web published form showing how a business is registered.

FIG. 4 illustrates a published form showing how an agent is registered.

FIG. 5 illustrates a published form showing how a worker is registered.

FIG. 6 is a chart illustrating the organisation of up to thirteen different access levels that a business may allocate to any of its users.

FIG. 7 is a chart illustrating the organisation of up to thirteen different access roles that an agent may allocate to any of its users.

FIG. 8 illustrates a web page showing exemplary fixed details for a profiling position.

FIG. 9 illustrates a web page showing selected nominated agents or all agents applicable to a quote.

FIG. 10 is a web page illustrating responses to quotation requests that have been received against the position profile from agents.

FIG. 11 illustrates a web page showing fixed and variable data required for the acceptance of a quotation.

FIG. 12 illustrates a web page showing fixed and variable data required for an order to be placed.

FIG. 13 illustrates a web page showing the fixed and variable data required for a report to be created.

### BEST MODE AND OTHER EMBODIMENTS OF THE INVENTION

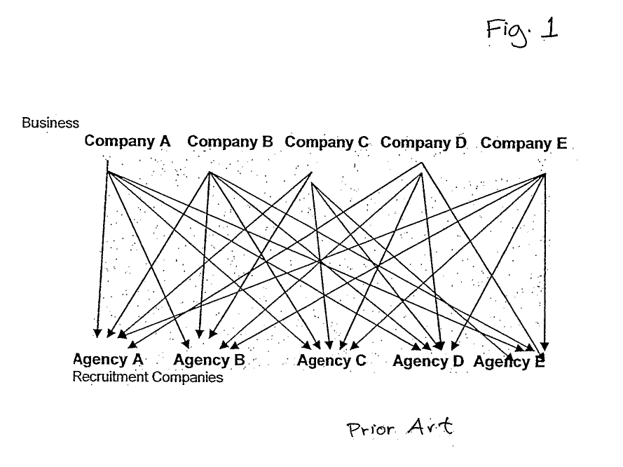

As shown in FIG. 1, prior art methods require a business or company seeking casual labour to contact multiple agencies and therefore conduct many transactions in the procurement and management of said labour.

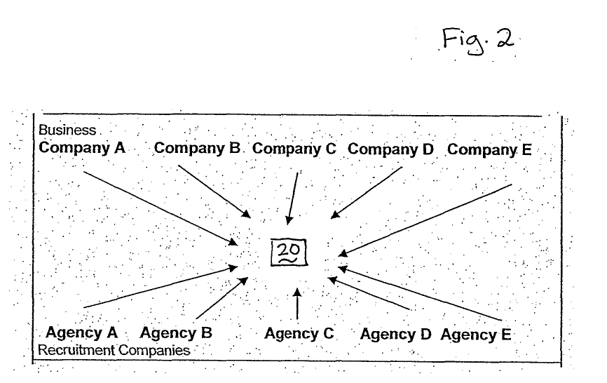

As shown in FIG. 2, the present invention provides a central web based site 20 that allows all participating companies and agencies to transact in a secure, coordinated fashion using only a conventional web browser.

In order that the invention may be more readily understood and put into practical effect, certain processes are described using the following stages or steps that are expanded upon in detail below:
user registration
administration setup
profiling positions
obtaining quotations
quotation response
accepting quotations
ordering casuals or contractors
profiling casual or contractor
selecting casual or contractors
generating timesheets from a the single source
the collection of information to a single location
the production of reports which are then distributable to users

Data analysis can be performed daily, weekly or at the time of payroll run by the buyer, supplier or casual. Reports can be created between user-entered start and finish dates and can be specified by location, department, profile or position. These reports can then be linked to the Agent's payroll and to Business Enterprise Resource Applications.

The methods of the present invention are implemented via a networked Application Service Provider (ASP) business model. The system serves to consolidate timesheet, OH&S and accident data into a single location, which would otherwise have to be gathered from a range of various sources. Employers who source from a variety of casual/contractor labour suppliers may use this invention to prepare reports of labour by location, department, position, job, project, order number, supplier over normal time, time and half, double time and allowances. The invention provides for searches to be done on a day-to-day basis for any of the above information categories.

It will be understood that the invention is described with reference to a browser-based interface to the World Wide Web (“web”). Accordingly, this invention is designed for use over a multi-user network such as the Internet. The system may be used by:
employers of casual/contractor labour (or permanent workers)
personnel companies (agents)
contractors
labourers

A user of the system must have access to a network such as the Internet and will preferably have web access, an e-mail address and preferably a mobile phone from which information may be sent or received (e.g. enter timesheet data).

### Registration

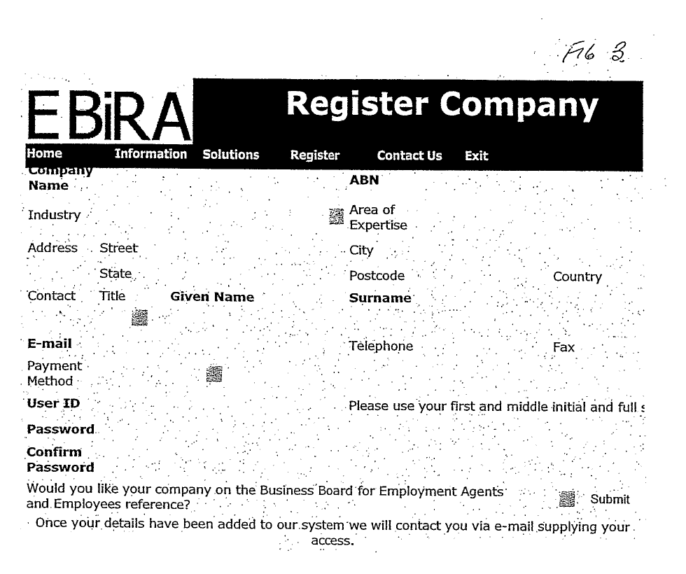

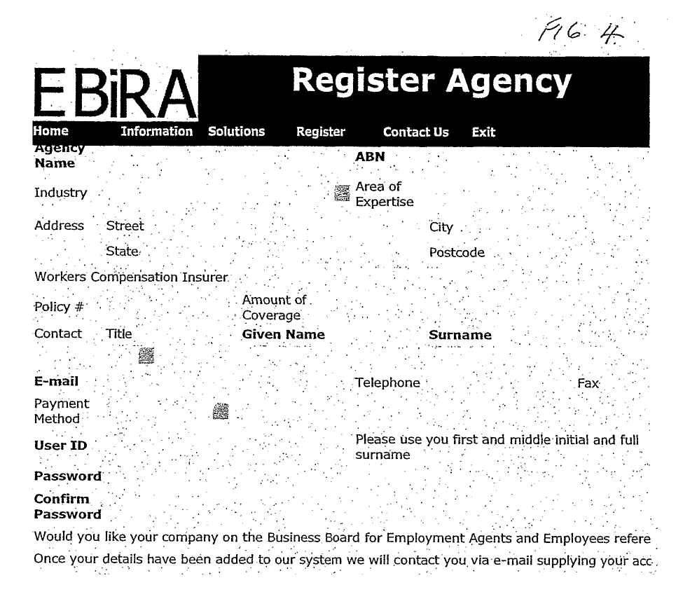

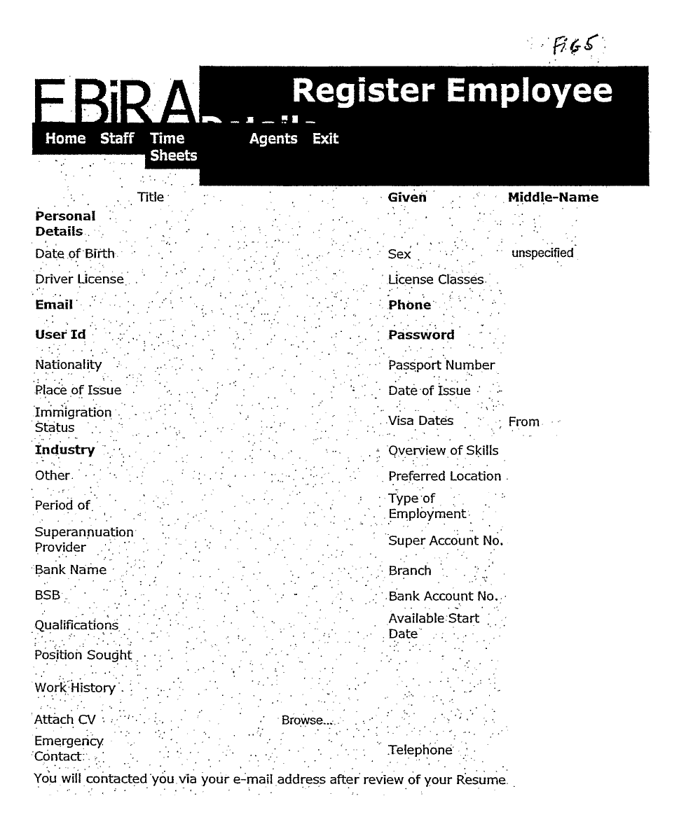

The first stage of the invention allows the three types of users (buyer or “business” or “company”; supplier or “agent”; and workers or labourers, contractors) to register so that they can use the invention. See FIG. 3 for the buyer business registration form, FIG. 4 for the agent registration form and FIG. 5 for the worker registration form.

### Administration

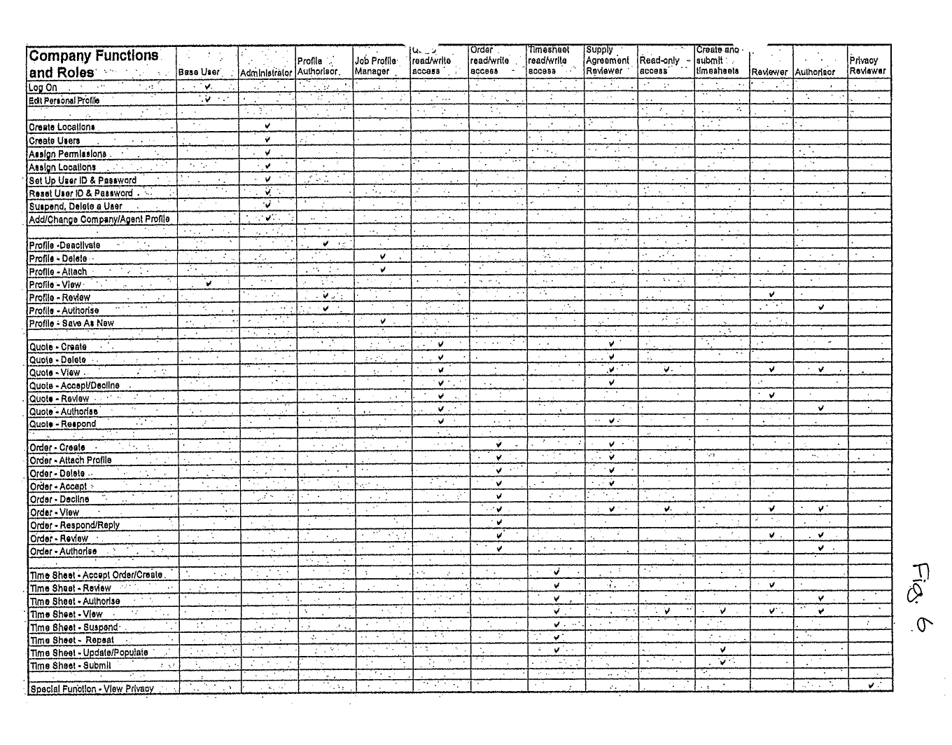

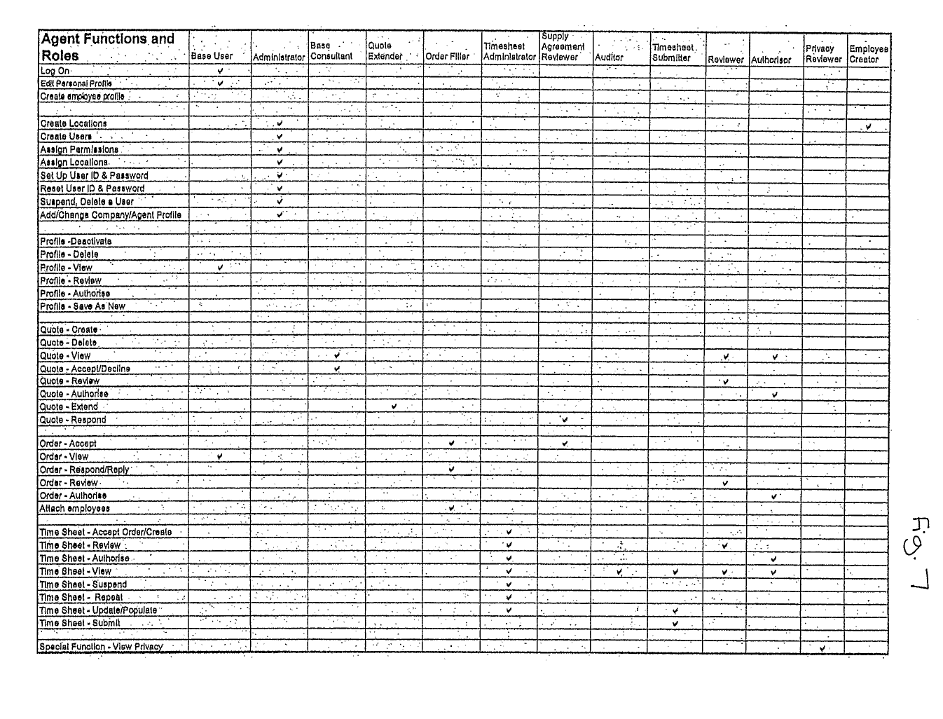

The invention allows each of the registered buyers and suppliers to manage and add their own users within their own organisation and set security and access levels. For a business, each of its users can be assigned by the business to any of up to, say, thirteen different access levels (see FIG. 6). For an agency, each of its users can be assigned by the agency to any of up to, say, thirteen different access levels (see FIG. 7). These access levels determine the extent of functionality the users have to the invention's information and Web pages. In the alternative, access privileges to a registered participant's users can be custom tailored by submission of web based forms.

The present invention also allows new users added by the buyer or supplier to be attached to a location, department or whatever the current reporting structure is for that organisation. This structure is a “parent-child” relationship so users will only see themselves and those reporting to them.

Businesses manage their own profile, their preferred suppliers which may or may not be used by the company staff when requesting quotes or placing orders.

### Profiling Positions

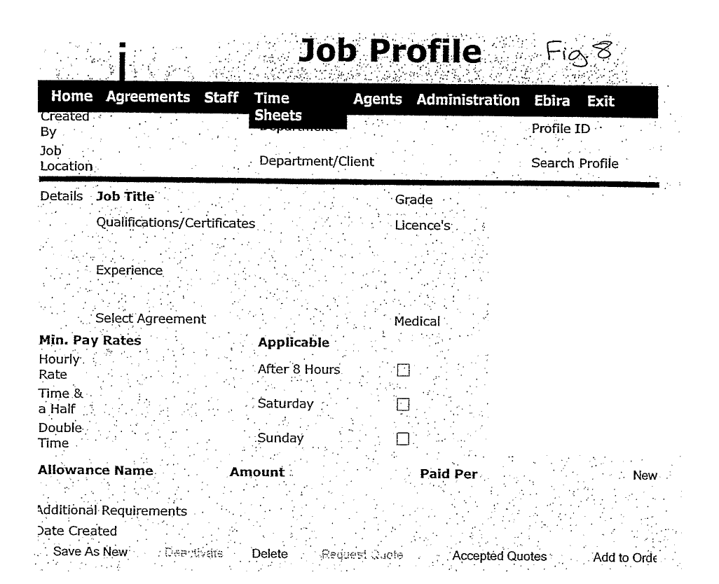

The second stage is to establish or set a position profile (job description), which lists all the fixed details regarding the position, which is then sent to the agent for a quote as shown in the form of FIG. 8. The position profile is used as the basis for allowing registered business users to add variable job details to the job profile when placing an order.

### Obtaining a Quotation

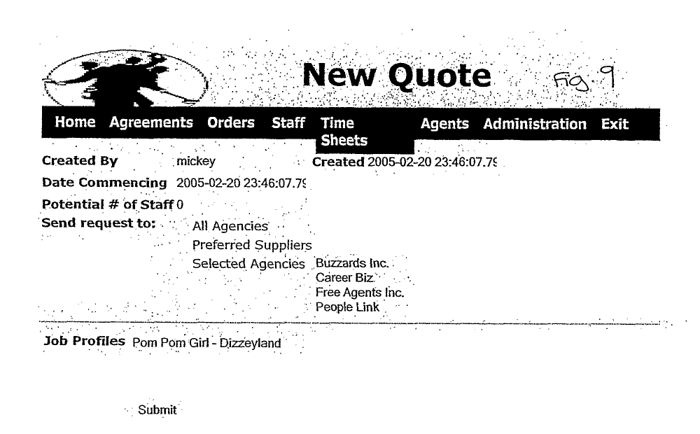

The third stage is to either contact preferred suppliers (as set in the registration profile) or selected nominated agents or to place on the quote board for all agents to quote on. When the supplier constructs the quote it lists the pay rate to casual, addition of its on-costs to arrive at a charge rate to the buyer (supported by a supplier preformed work sheet). The request for quotations is broadcast to agents etc. by email and SMS alerts. See FIG. 9.

Businesses may also source directly casual labour as they may advertise a position for response by the casual or search the registered worker database for the relevant experience.

### Quotation Response

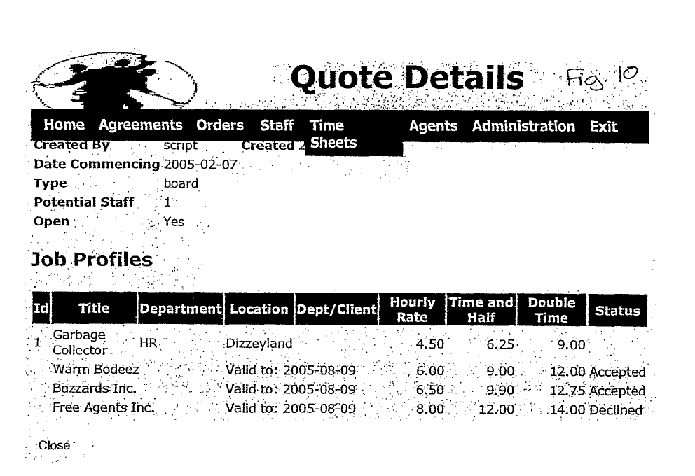

In the fourth stage, all responses to quotation requests that have been received against the position profile from agents, who are supported by email and SMS are shown in FIG. 10. This is the web based publication that represents a reply from the agencies to the quote request sent to them by the business in the third stage.

### Accepting a Quotation

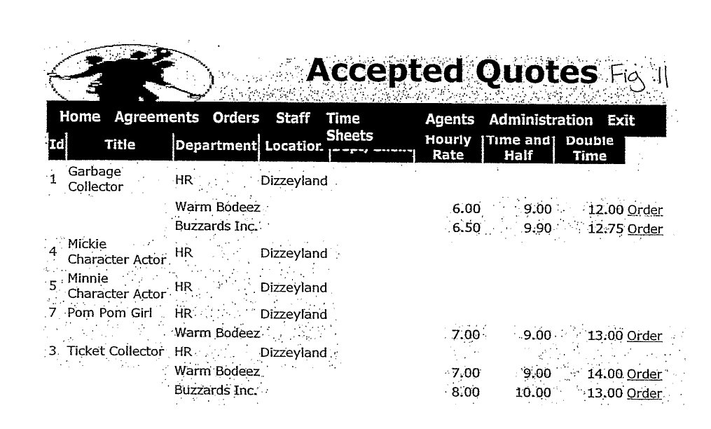

In stage five, the company has the option of e.g. using the site's published forms for accepting or declining the agent's quotation and has the ability to add an on-cost rate (overheads related to that position) and a charge-out rate which it may use when on-charging the casual to a third party. The acceptance/rejection is supported by email and SMS notification to the respective suppliers. Refer to FIG. 11.

### Ordering

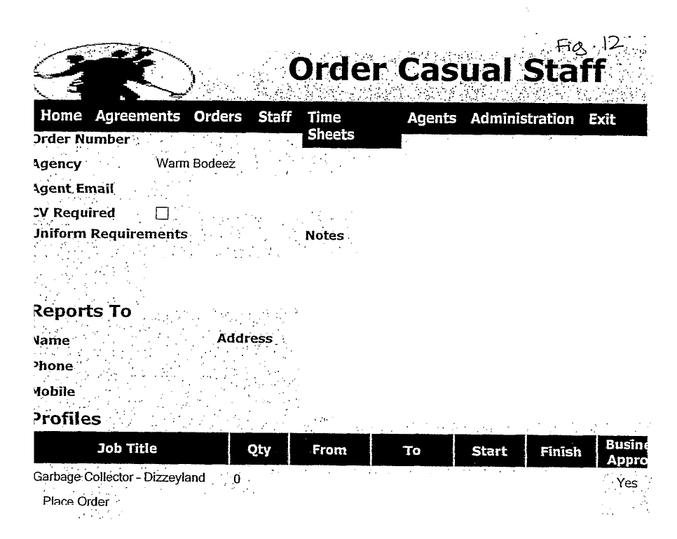

The sixth stage is the actual order. This is where the company user who is placing the order, with web based forms, to a selected agent, adds the variable details about the job to the position profile from FIG. 9 to the order. The order captures all relevant data required to fill the order such as job profile, number of casuals, date required, time required, duration pay & charge rate, order number, person reporting to, and all contact details. The order is supported by email and SMS. This is shown on FIG. 12.

### Profiling Casual/Contractors

The seventh stage is the listing, by web publication, of the details of the worker for review by the buyer that the agent has sent to fulfill the vacant positions generated by the business. The business may view the CV (curriculum vitae) of the worker if it has been requested. The worker being put forward by the supplier is given the option of accepting the assignment either by e.g. phone, email or SMS

### Selecting Casual/Contractors

In the eighth stage the business has the ability to accept or decline a profiled casual/contractor supplied from the agency. This action is supported by email and SMS to both the supplier and worker

### Generating a Timesheet

In the ninth stage, a timesheet is automatically generated when a business accepts the profile of the casual/contractor supplied by the agency. The time sheet is publishable to and viewable by the buyer, supplier and casual on the web.

### Completion of a Timesheet

In the tenth stage, the worker (or supervisor) fills in the automatically generated timesheet, either daily or as required, with the hours worked so that it can be authorised and processed.

### Authorizing Timesheets

In the eleventh stage, the business is able to authorise or decline the submitted timesheet on-line. Where it is declined the employee and supplier will be notified by email with comment and asked to re-submit for authorisation.

### Report Production

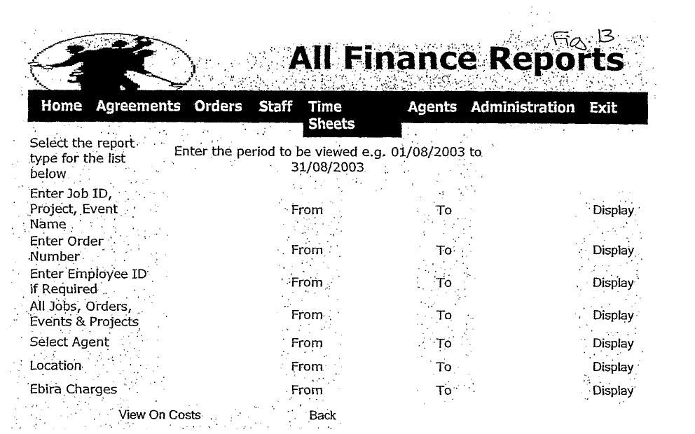

The invention allows the users to select reports as detailed in FIG. 13. The report parameters can be set by the user rather than have fixed reports generated by the system.

Agencies can have reports generated for payroll reporting purposes that can then be downloaded to their payroll system.

This invention allows the production of a range of reports such as:
Payroll Report for supplier—This report is for payroll purposes and lists employees by agency or cost center, showing the hours worked by the employee for a given time period. Analysis details from this report include pay rates for normal time, time and a half, and double time, as well as allowances. The report will be produced in a form that may allow automatic download to external payroll systems, such as via a CSV file.
Cost Report for supplier—This report is similar to the Payroll Report except it uses on-cost rates instead of pay rates for supplier to manage their profit on each worker
Client Charge Report for supplier—This report is similar to the Payroll Report except it uses charge rates instead of pay rates. This report will list all buyers showing details of all buyers it has supplied for the period selected.
Supplier Charge Report for buyers—This report is mirror image of the Clients Charge Report as it uses charge rates quoted by the supplier. This report will list all suppliers showing details of all the suppliers for the period selected.
Cost Report for buyer—This report is similar to the Charge Report except it uses on-cost rates instead of charge rates for buyer to manage their profit. Cost Report for supplier—This report is similar to the Payroll Report except it uses cost rates instead of pay rates for supplier to manage their profit
Charge report for buyer—This reports enables the buyer to track charge out rates it has set against cost centers. This is used for on billing.
Comparison Report—This report compares pay rates, cost rates and charge rates for each employee over a given time period either by cost center, project or event.

The invention is made secure owing to the use of user id and passwords, multiple daily backups, encryption and offsite storage.

All of the information required by a buyer of labour is provided from a single location giving it control and flexibility with regard to the generation of reports. The system being a single link between buyers and multiple agents can therefore provide the ability to gauge labour costs before a payroll is run.

The system will thus allow the buyer and supplier to manage all their internal data between different departments to different location for the procurement and management of timesheet employees. All transactions are supported by a comprehensive audit trail.

What is claimed is:

1. A method for doing business, for enabling multiple participating labour buyer users to transact with multiple agency users in the procurement of labour services in a secure, coordinated fashion, from a web site and requiring the users to use only a conventional web browser, comprising the steps of:
publishing to each user a registration form for capturing relevant information to a database;
enabling users to define internal access rights using security settings determined by the reply to an administration form published to the users;
publishing to a buyer, a profile form for profiling a position, capturing the information from the profile form and using that information to publish a position availability to one or more agency users;
publishing a form to enable a requesting buyer to obtain quotations from one or more agency users;
enabling the requesting buyer users to obtaining one or more quotation responses from at least one agency by publishing only to the requesting buyer, the one or more quotation responses constructed by participating agencies;
enabling the requesting buyer to accept or decline a quotation response;
enabling the requesting buyer to order with a web form, from a selected agent, labour corresponding to a position availability.

2. The method of claim 1, further comprising the step of:
enabling a requesting buyer to place an order with web based forms to a selected agent.

3. The method of claim 1, further comprising the step of:
publishing a profile of a worker, being of details of a worker for review by the requesting buyer.

4. The method of claim 3, further comprising the step of:
receiving an acceptance or refusal of a worker for whom a profile has been published.

5. The method of claim 1, further comprising the step of:
generating a timesheet when a requesting buyer accepts a profile of a worker supplied by an agency, the timesheet being published on the web for viewing only by the worker, the requesting buyer and the participating agency.

6. The method of claim 5, further comprising the step of:
enabling a requesting buyer to authorise or decline a timesheet that has been submitted on-line.

7. The method of claim 6, further comprising the step of:
generating an email to an agency when a timesheet has been declined, the email containing a request to resubmit the timesheet.

8. The method of claim 1, further comprising the step of:
enabling a user to generate a report, publishable to only a report requesting user, according to parameters selected by a web based form and selected by the user.

9. The method of claim 8, wherein:
the reports can be created between a user-entered start and finish date and can be specified by parameters including but not limited to location, department, profile or position; these reports being linkable to the agency's payroll or business enterprise resource applications.

10. The method of claim 1, wherein accepting a quotation response further comprises:
enabling the requesting buyer to add an on-cost rate or charge out rate.

11. The method of claim 1, wherein ordering further comprises:
capturing data relevant to an order, that data comprising any one or more of: job profile, number of workers required, time required, duration of job, pay and charge rate, order number or contact details.

12. The method of claim. 3, wherein publishing a profile of a worker further comprises:
the worker is enabled to accept an assignment by phone, email or SMS.

13. The method of claim 8, wherein:
the report is a payroll report for an agency that lists workers by agency or cost centre, showing hours worked for a given buyer for a given period of time, the report downloadable to an external payroll system.

14. The method of claim 13, wherein:
the report is similar to a payroll report except that it uses on-cost rates instead of pay rates for an agency supplier to manage a profit associated with a worker.

15. The method of claim 8, wherein:
the report is a supplier charge report for buyers, using charge rates quoted by the agency and listing all agencies showing details of all the suppliers for the period selected.

16. The method of claim 8, wherein:
the report is a cost report for buyer, the report using uses on-cost rates instead of charge rates for the buyer to manage their profit.

17. The method of claim 8, wherein:
the report is a cost report for the agency, using cost rates instead of pay rates for the agency to manage their profit.

19. The method of claim 8, wherein:
the report is a charge report for buyer, enabling the buyer to track charge out rates it has set against cost centers.

20. The method of claim 8, wherein:
the report is a comparison report comparing pay rates, cost rates and charge rates for each employee over a given time period either by cost center, project or event.
